(19) United States
(12) Patent Application Publication
(10) Pub. No.: US 2017/0175942 A1
(43) Pub. Date: Jun. 22, 2017

(54) METHOD FOR LINING A PIPE

(71) Applicant: SHONAN GOSEI-JUSHI SEISAKUSHO K.K., Hiratsuka-shi (JP)

(72) Inventors: Takao KAMIYAMA, Hiratsuka-shi (JP); Kazuaki OGURA, Hiratsuka-shi (JP)

(21) Appl. No.: 15/357,518

(22) Filed: Nov. 21, 2016

(30) Foreign Application Priority Data
Dec. 18, 2015 (JP) 2015-248007

(51) Int. Cl. F16L 55/165

(52) U.S. Cl. CPC F16L 55/1651; F16L 55/1656; B05B 9/002

(57) ABSTRACT

A pipe lining material impregnated with a thermosetting resin is inserted into a pipe and the thermosetting resin impregnated therein is cured to line the pipe with the pipe lining material. A circulation pump is used to circulate water in a water tank to a boiler to heat the water into hot water. The hot water is pumped using a spraying pump and sprayed on the pipe lining material to cure the thermosetting resin impregnated therein. After the thermosetting resin has been cured, the hot water pumped using the circulation pump is circulated to a cooler to cool the hot water into cool water, which is sprayed on the cured thermosetting resin to cool it. The sprayed hot or cool water that remains inside the lined pipe is returned to the water tank for circulation to the boiler or the cooler.

### BACKGROUND OF THE INVENTION

Field of the Invention

The present invention relates to a method for lining a pipe, and more specifically relates to a method for lining a pipe in order to rehabilitate a pipeline such as an aged sewer pipe.

Description of the Related Art

Pipeline lining methods have been known in which a pipeline such as a sewer pipe buried under ground can be rehabilitated without removing it therefrom. In this method, a tubular flexible pipe lining material impregnated with a thermosetting resin is pulled or everted for insertion into the pipeline, and it is expanded by air pressure or the like and pressed against an inner peripheral surface of the pipeline. Hot water heated by a boiler is then sprayed against the pipe lining material to cure the thermosetting resin impregnated therein, thereby lining the pipeline.

To heat and cure the pipe lining material, a method is employed in which steam or a hot water shower is used or the pipe is filled with hot water. Since the pipe lining material is still hot after it has been cured, cool water is prepared by a separate water-supplying truck, and srayed onto the pipe lining material to cool the hot pipe lining material. However, the cooling is ineffective because the cool water is sprayed into the hot water using the water-supplying truck.

To cool the pipe lining material, a method is known as proposed in JP 2008-1078 A in which the used hot water remaining inside the pipe or the hot water produced from the used steam is pumped and cooled into cool water, which is then used to cool the pipe lining material without using the separate water-supplying truck.

However, in the method as described in JP 2008-1078 A, to operate a cooler to cool the used hot water that remains inside the pipe, it is necessary to stop the boiler operation after the thermosetting resin impregnated in the pipe lining material has been cured. A problem therefore arises in that the pipe lining material is cooled ineffectively.

Therefore, it is an object of the invention to provide an inexpensive pipe lining method that enables the pipe lining material to be uniformly heated and cured at a low cost and the thermally cured pipe lining material to be cooled effectively.

### SUMMARY OF THE INVENTION

The invention relates to a method for lining a pipe in which a tubular pipe lining material impregnated with a thermosetting resin is inserted into a pipe and the thermosetting resin impregnated therein is cured to line the pipe with the pipe lining material. The pipe lining material inserted into the pipe is expanded to press against an inner peripheral surface thereof. Water in a water tank is circulated using a circulation pump to a boiler to heat the water in the water tank into hot water. The hot water is pumped using a spraying pump and sprayed on the pipe lining material pressed against the inner peripheral surface of the pipe in order to cure the thermosetting resin impregnated in the pipe lining material. The sprayed hot water remaining inside the lined pipe is returned to the water tank. The hot water pumped from the circulation pump is circulated to a cooler to cool the hot water into cool water after the thermosetting resin has been cured. The cool water is sprayed using the spraying pump on the cured thermosetting resin in order to cool the thermosetting resin. The sprayed cool water remaining inside the lined pipe is returned to the water tank for circulation to the cooler.

In the present invention, when cooling the pipe lining material, hot water that is pumped from the water tank by the circulation pump and circulated to the boiler is not supplied to the boiler, but to the cooler. The same circulation pump is used to circulate the hot water to the cooler, thereby enabling cool water to be produced effectively with a simple mechanism.

Furthermore, in the present embodiment, the circulation pump for circulating water in the water tank to the boiler or the cooler is separate from the spraying pump, so that, when switched from the boiler to the cooler, the hot water in the water tank is gradually cooled in accordance with circulation to the cooler. Therefore, it is possible to pump the gradually cooled water by the spraying pump without rapidly cooling the pipe lining material, thus enabling a good quality lining to be performed.

Further features of the invention, its nature and various advantages will be more apparent from the accompanying drawings and following detailed description of the invention.

### BRIEF DESCRIPTION OF THE DRAWINGS

FIG. 1 is an illustrative view showing a state in which a pipe lining material is everted and inserted into a main pipe;

FIG. 2 is an illustrative view showing a state in which a thermosetting resin impregnated in the pipe lining material is cured or cooled;

FIG. 3 is an illustrative view showing a pipe arrangement for heating or cooling water in a water tank; and

FIG. 4 is an illustrative view showing an arrangement of a water tank, a boiler, a cooler and the like on a work truck.

### DESCRIPTION OF THE PREFERRED EMBODIMENTS

The present invention will now be described in detail with reference to the embodiments shown in the accompanying drawings.

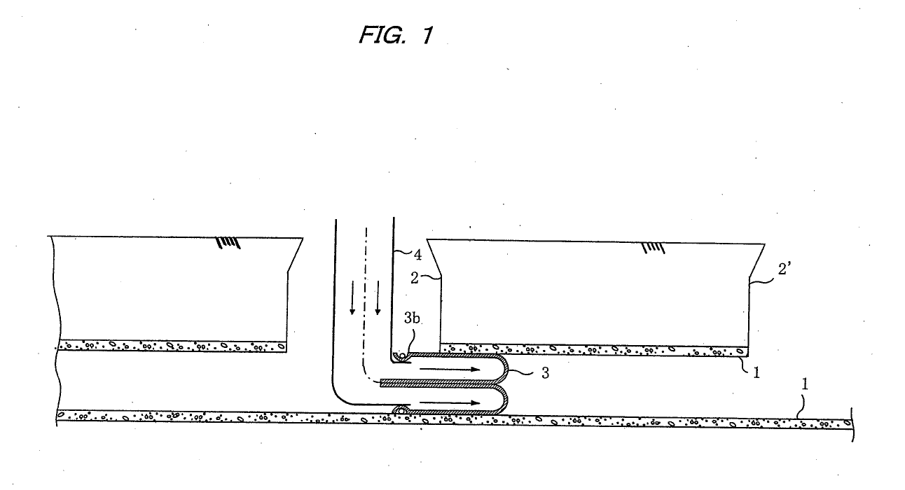

In FIG. 1, the reference symbol 1 indicates a main pipe such as a sewer pipe, a water supply pipe or the like buried under ground. When the main pipe 1 is to be repaired, a flexible tubular pipe lining material 3 is inserted into the main pipe 1 through a guide pipe 4 connected to an everting apparatus (not shown) from a manhole 2 that is in communication with the main pipe 1. The pipe lining material 3 is supplied with compressed air or another pressurized medium from the everting apparatus. This causes the pipe lining material 3 to be turned inside out and inserted into the main pipe 1. The insertion of the pipe lining material 3 is not only performed by an everting method, but also by a pulling method in which the pipe lining material 3 is pulled in from anther manhole 2′.

The pipe lining material 3 is made of a non-woven fabric composed of a fiber such as polyester, vinylon, acrylic, a complex non-woven fabric of an added reinforced material such as a glass fiber, or a woven fabric that is sewn into a tubular shape to form a flexible tubular resin-absorbing material with its one surface (a surface that is the exterior surface before being everted and inserted into the pipeline 1) being covered by a highly airtight film. The resin-absorbing material is impregnated with unsaturated polyester resin, vinyl ester resin, epoxy resin, or another thermosetting resin. The pipe lining material 3 is closed at a distal end 3a and connected to a medium supply hose 5, as will be described later. The rear end 3b of the pipe lining material 3 is coupled in airtight fashion to the lower end of the guide pipe 4 disposed in the manhole 2.

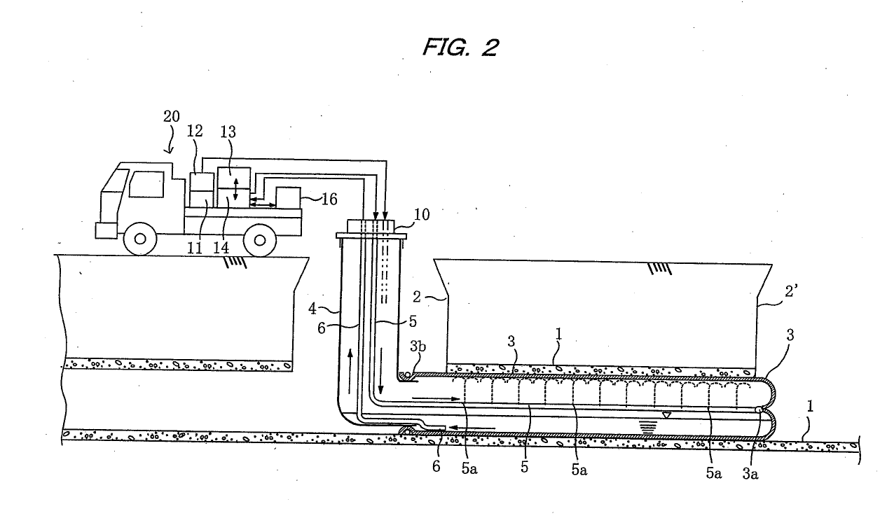

The pipe lining material 3 is everted and inserted into the main pipe 1 until its distal end reaches another manhole 2′, as shown in FIG. 2. When the insertion of the pipe lining material 3 is completed, a work truck 20 is transported near the manhole 2. A mount pipe 10 is then coupled to the guide pipe 4. In a case in which the pipe lining material is inserted by the pulling method, the pipe lining material is pulled and inserted into the maim pipe by pulling the pipe lining material from the manhole 2′ using a winch that is installed on the ground.

A generator 11, a compressor 12, a boiler 13, a water tank 14, a cooler 16 such as a radiator, and the like are loaded on the bed of the work truck 20.

The medium supply hose 5 with its distal end connected to the end 3a of the pipe lining material 3 is inserted into the main pipe 1 as the pipe lining material 3 is inserted into the main pipe 1. When the eversion and insertion of the pipe lining material 3 is completed, the other end of the medium supply hose 5 is connected through the mount pipe 10 to the water tank 14 that is loaded on the work truck 20. A plurality of spray holes 5a is formed at equal intervals on a portion of the medium supply hose 5 corresponding to the length of the main pipe 1. Hot water or cool water is sprayed from the spray holes 5a on the pipe lining material 3, as will be described later.

Also when the insertion of the pipe lining material 3 is completed, a drain hose 6 for returning to the water tank 14 the sprayed hot or cool water remaining inside the main pipe 1 is inserted through the mount pipe 10 and the guide pipe 4 into the main pipe 1.

Compressed air is also supplied from the compressor 12 in order to expand the pipe lining material 3 in the main pipe 1 against the inner surface thereof 3.

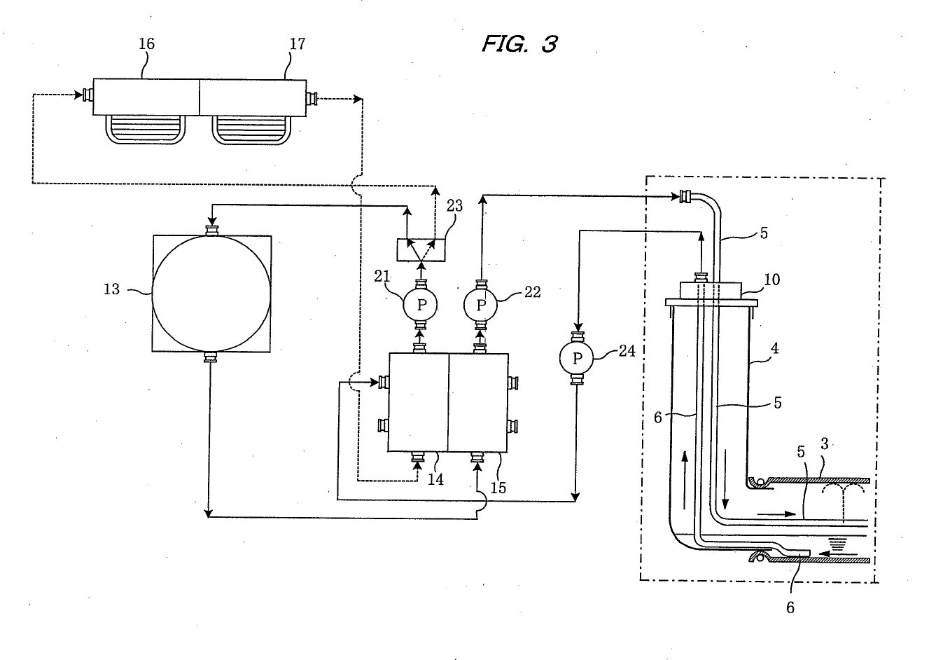

FIG. 3 shows a piping system in which water in the water tank is heated into hot water and the hot water is cooled into cool water. In the system in FIG. 3, another water tank 15 is connected to the water tank 14, and an additional cooler 17 is connected to the cooler 16. The water tank or the cooler increases or decreases in number depending on the required amount of hot or cool water and its required temperature. In FIG. 3, the pipes or hoses to which the components are connected are shown simply as lines together with arrows indicating the direction along which the medium flows.

In FIG. 3, the boiler 13 is operated in a case where the thermosetting resin in the pipe lining material 3 is to be heated. Water in the water tanks 14, 15 is pumped by a circulation pump 21, and supplied through a three-way switching valve 23 to the boiler 13, then returning to the water tanks 14, 15. This causes the water in the water tanks 14, 15 to be circulated through the three-way switching valve 23 to the boiler 13 and heated into hot water. In the case a plurality of water tanks are connected, the water in the water tanks flows in communication with each other such that its temperature is substantially the same. Therefore, the individual water tanks can be regarded as being equivalent to a single water tank having a large capacity.

Hot water in the water tanks 14, 15 heated by the boiler 13 is pumped by a spraying pump 22 and supplied to the medium supply hose 5. The hot water is sprayed through the spray holes 5a to shower the pipe lining material 3 pressed against the inner surface of the main pipe 1 and cure the thermosetting resin impregnated therein. In a case where the main pipe is filled with hot water to cure the thermosetting resin, the hot water is sprayed more in the vicinity of the distal end 3a of the pipe lining material 3 in order to drain the sprayed hot water through the drain hose 6 for circulation to the boiler 13.

The sprayed hot water remains inside the main pipe 1 that is lined with the lining material 3, so that the sprayed hot water is pumped through the drain hose 6 by an inner pressure in the main pipe or additionally using an auxiliary pump 24 and is returned to the water tanks 14, 15. The hot water thus returned to the water tanks 14, 15 is again heated by the boiler 13, and pumped by the spraying pump 22 for use to heat the pipe lining material 3 again.

After the thermosetting resin in the pipe lining material 3 has been cured, the pipe lining material 3 is still hot, so that it is necessary to cool the pipe lining material 3. When the pipe lining material 3 is to be cooled, the three-way switching valve 23 is driven to switch the flow of hot water in the water tanks 14, 15 pumped by the circulation pump 21 to the direction toward the coolers 16, 17, as shown by the dotted line. When cooling the pipe lining material 3, it is preferable to operate the coolers 16, 17 in advance and to stop the operation of the boiler 13.

Once the three-way valve 23 has been switched, hot water in the water tanks 14, 15 is circulated to the coolers 16, 17 by the circulation pump 21, and the hot water in the water tanks 14, 15 is gradually cooled into cool water. The flow of cool water circulating in the coolers 16, 17 is shown by the dotted line.

Similarly to the circulation pump 21, the spraying pump 22 and the auxiliary pump 24 are also in operation even while the pipe lining material 3 is cooled. Therefore, the water cooled by the coolers 16, 17 is pumped from the water tanks 14, 15 by the spraying pump 22 and sprayed from the spray holes 5a of the medium supply hose 5 toward the pipe lining material 3 to shower the pipe lining material 3 in order to gradually cool it. In a case where the main pipe is filled with cool water to cool the thermosetting resin, the cool water is sprayed more in the vicinity of the distal end 3a of the pipe lining material 3 in order to drain the sprayed cool water through the drain hose 6 for circulation to the coolers 16, 17.

The sprayed cool water is pumped through the drain hose 6 by an inner pressure in the main pipe or additionally using the auxiliary pump 24, and is returned to the water tanks 14, 15. The cool water thus returned to the water tanks 14, 15 is again cooled by the coolers 16, 17 and pumped by the spraying pump 22 for use to cool the pipe lining material 3 again.

When the pipe lining material 3 has been cooled, the guide pipe 4 and the like are removed from the manhole 2, and the pipe lining material protruding into the manholes 2, 2′ is cut off, thus completing the lining work.

In the present embodiment, when cooling the pipe lining material, hot water that is pumped from the water tank by the circulation pump and circulated to the boiler is not supplied to the boiler, but to the cooler. The same circulation pump is thus used to circulate the hot water to the cooler, thereby enabling cool water to be produced effectively with a simple mechanism.

In the present embodiment, the circulation pump for circulating water in the water tank to the boiler or the cooler is separate from the spraying pump, so that, when switched from the boiler to the cooler, the hot water in the water tank is gradually cooled in accordance with circulation to the cooler. Therefore, it is possible to pump the gradually cooled water by the spraying pump without rapidly cooling the pipe lining material, thus enabling a good quality lining to be performed.

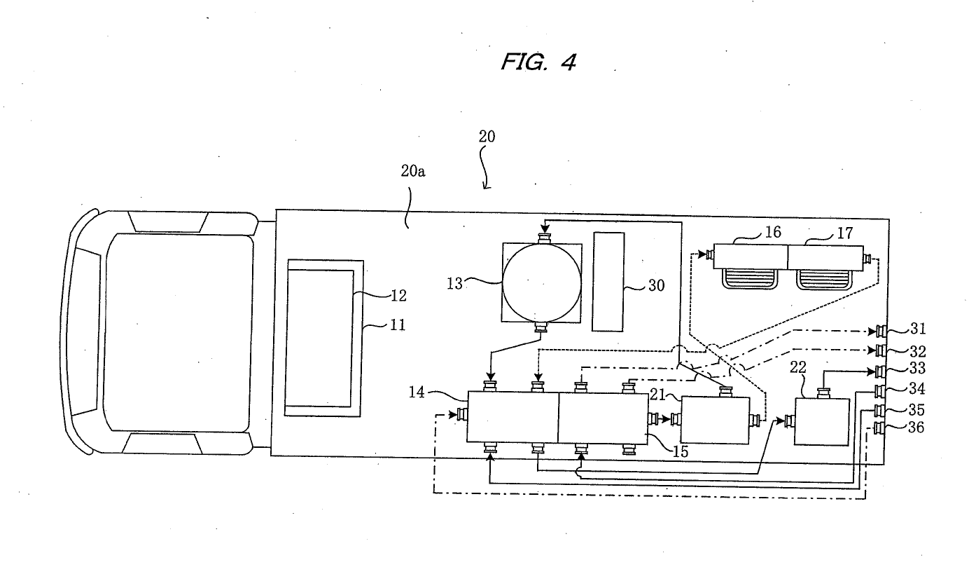

FIG. 4 shows an arrangement of the boiler 13, the water tanks 14, 15, the coolers 16, 17, and the like that are loaded on the bed 20a of the work truck 20. The generator 11 is disposed on the bed 20a in the front thereof as seen in the direction of travel and the compressor 12 is mounted thereon. The boiler 13 is disposed on the bed 20a at the central part on the right side thereof, the water tanks 14, 15 at the central part on the left side, the coolers 16, 17 on the right side at the rear thereof, and the circulation pump 21 and the spraying pump 22 on the left side at the rear thereof.

An operation panel 30 is provided with power supply switches for the boiler 13 and the coolers 16, 17; a switch for the three-way switching valve 23, a button for setting a temperature in the water tank; buttons for adjusting a supply pressure and an amount of supply for hot or cool water; and the like. In FIG. 4, the three-way switching valve is integrated inside the circulation pump 21.

The arrangement of the pipes or the hoses to which the boiler 13, the water tanks 14, 15, the coolers 16, 17, the circulation pump 21 and the spraying pump 22 are connected corresponds to that shown in FIG. 3, and the cool-piping system is shown by the dotted line. The connection of the pipes and the hoses to the components is performed using a cam lock mechanism or a parrot system. The boiler 13, the water tanks 14, 15, the coolers 16, 17, the circulation pump 21 and the spraying pump 22 are equipped with connectors with which the pipes or the hoses are connected.

Furthermore, connectors 31 through 36 to which the pipes and the hoses are connected are disposed on the bed 20a of the work truck 20 at the rear thereof. The medium supply hose 5 is connected to the connector 33 to supply thereto hot water pumped from the water tanks 14, 15 by the spraying pump 22. A hose is connected to the connector 35 to return to the water tanks 14, 15 the sprayed hot or cool water that remains inside the lined main pipe. The return of hot or cool water to the water tanks 14, 15 is performed by an inner pressure in the main pipe or additionally using the auxiliary pump 24.

The connectors 31 and 32 are additionally used to connect other medium supply hoses different from the medium supply hose 5 in a case where hot or cool water is needed more than that supplied by the medium supply hose 5. The connector 36 is also additionally used to connect a drain hose different from the drain force 6 in a case where the sprayed hot or cool water remaining inside the lined main pipe must be drained more. The piping arrangement of these connectors are virtually shown by the dashed lines, respectively, showing a high specification for supply of a large amount of hot or cool water. Preferably, the increased water tank and cooler are loaded on the existing water tank and cooler in order to save the bed space.

The water tank, the boiler, the cooler and the like can thus be loaded on one work truck for transportation to a work site, ensuring an efficient lining work.

What is claimed is:

1. A method for lining a pipe in which a tubular pipe lining material impregnated with a thermosetting resin is inserted into a pipe and the thermosetting resin impregnated therein is cured to line the pipe with the pipe lining material, comprising:
expanding the pipe lining material inserted into the pipe to press against an inner peripheral surface thereof;
circulating water in a water tank using a circulation pump to a boiler to heat the water in the water tank into hot water;
pumping the hot water using a spraying pump to spray the hot water on the pipe lining material pressed against the inner peripheral surface of the pipe in order to cure the thermosetting resin impregnated in the pipe lining material;
returning the sprayed hot water remaining inside the lined pipe to the water tank;
circulating the hot water pumped from the circulation pump to a cooler to cool the hot water into cool water after the thermosetting resin has been cured;
pumping the cool water using the spraying pump to spray on the cured thermosetting resin in order to cool the thermosetting resin; and
returning the sprayed cool water remaining inside the lined pipe to the water tank for circulation to the cooler.

2. A method for lining a pipe according to claim 1, wherein a switching valve is used to switch the flow of water in the water tank for circulation to the boiler or the cooler.

3. A method for lining a pipe according to claim 2, wherein the switching valve is a three-way switching valve that switches the flow of water pumped from the circulation pump toward the boiler or the cooler.

4. A method for lining a pipe according to claim 1, wherein an auxiliary valve is used to return the sprayed hot or cool water remaining inside the lined pipe to the water tank.

5. A method for lining a pipe according to claim 1, wherein the water tank, the boiler and the cooler are loaded on one work truck and transported to a work site.
